(19) United States
(12) Patent Application Publication
(10) Pub. No.: US 2015/0228404 A1
(43) Pub. Date: Aug. 13, 2015

(54) Coil Wire Support Element, Manufacturing Method Thereof, and Inductive Power Transfer Coupler Incorprationg The Same

(71) Applicant: Tyco Electronics Belgium EC BVBA, Oostkamp (BE)

(72) Inventors: Guus Mertens, Massemen (BE); Hans De Brauwer, Damme (BE); Peter Okkerse, Rhenoy (NL); Peter Dirk Jaeger, Dussen (NL)

(73) Assignee: Tyco Electronics Belgium EC BVBA, Oostkamp (BE)

(21) Appl. No.: 14/695,799

(22) Filed: Apr. 24, 2015

Related U.S. Application Data
(63) Continuation of application No. PCT/EP2013/071751, filed on Oct. 17, 2013.

(30) Foreign Application Priority Data
Oct. 26, 2012 (EP) 12190166.4

(51) Int. Cl. H01F 38/14; H01F 41/06; H01F 27/28

(52) U.S. Cl. CPC H01F 38/14; H01F 27/2823; H01F 41/0612; H01F 2005/022

(57) ABSTRACT

A coil wire support element is provided and includes a support member and a coil wire section. The support member includes a front wall and a back wall arranged at the respective ends of the support member. The front wall and back wall extend away from the support member. The coil wire section includes a wire coiled on the support member in a coil wire layer such that a height h3 of the coil wire layer is larger a height h1 of the front wall.

### CROSS-REFERENCE TO RELATED APPLICATION

This application claims the benefit of the filing date under 35 U.S.C. §119(a)-(d) of PCT Patent Application No. PCT/EP2013/071751 filed on Oct. 17, 2013, which claims priority under 35 U.S.C. §119 to European Patent Application No. 12190166.4, filed Oct. 26, 2012.

### FIELD OF THE INVENTION

The invention relates to a coil wire support element and, more particularly, to a coil wire support element for use in an inductive power transfer coupler.

### BACKGROUND

Coil wire support elements are commonly known as integral parts for inductive power transfer couplers. Coil wire support elements may also be referred to as spool carriers or bobbins. There, the coil wire support elements provide structural support to a coiled wire. The coiled wire enables to inductively transfer power between inductive power transfer couplers of same or similar kind. Specifically, coil wire support elements are used for coiling the wire in predefined geometries, as for instance, in coil wire sections of predefined length and height. The height of a coil wire section is varied according to the number of coil wire layers adjacently arranged on top of each other.

In the context of the invention, a coil wire layer is to be understood as an arrangement of coil wire that is coiled on a structural member in a same direction (i.e. where subsequent coil wire loops are laterally displaced to each other in a same direction). In this respect, two adjacent coil wire layers differ in that the coiling direction between a first coil wire layer and a second coil wire layer are coiled in reverse. Assuming for example a cylindrical member on which the coil wire is to be coiled, subsequent coil wire loops of a first coil wire layer are laterally displaced to each other in a first axial direction of the cylindrical member, and coil wire loops of a second, overlying coil wire layer are laterally displaced to each other in a second, reversed axial direction.

Further, in the context of the invention a coil wire section is to be understood as an arrangement of coil wire in at least one coil wire layer includes a predefined geometry. For example, the geometry of the coil wire section may be fixed by a structural member, on which the coil wire of the coil wire section is coiled, and by the member's side walls, which limit the length of the coil wire section. Regardless, the height of a coil wire section depends on the number of coil wire layers, and hence is defined by the arrangement of the coil wire, coiled on the support member in the at least one coil wire layer.

It can be readily appreciated, that the provision of a plurality of coil wire layer on top of each other in a coil wire section improves an inductive power transfer efficiency of the coil while maintaining the length of the coil wire section constant. An increase in the loop number of the coil wire results in a higher electromotive force. Accordingly, inductive power transfer couplers make use of the effect in providing a plurality of coil wire layers on top of each other.

However, manufacturing coil wire section with a plurality of coil wire layers on top of each other is complicated without structural support (i.e. without coil wire support element).

For this purpose, the coil wire support member provides structural support for coiling thereon the coil wire in the plurality of coil wire layers.

Generally, known coil wire layers include a front and a back wall at the respective ends of the support member to provide lateral support for the coil wire during coiling of the plurality of coil wire layers.

Advantageously, the front and back wall also prevent from imperfections during coiling of the plurality of coil wire layers due to bonding thereof to the winding machine, e.g. the winding mandrel. Also, the front and back wall of the support member protect the coil wire layers from damage during the subsequent manufacturing steps, i.e. before the coil is mounted in a final product.

Notwithstanding the advantages noted above, the provision of walls at the ends of the support member also has a disadvantageous effect on the inductive power transmission efficiency when using such coil wire support elements in an inductive power transfer coupler.

Specifically, the front wall adds to the minimum distance at which the coil wire of one inductive power transfer coupler and another coil wire of the receptacle inductive power transfer coupler can be located. In other words, the thicker the front wall of the coil wire support element, the wider the space between the coils of interacting inductive power transfer couplers. A wide space between the coils of interacting inductive power transfer couplers results in a poor inductive power transmission efficiency.

Further, the front wall of the coil wire support element acts as an electromagnetic shielding to the electromotive force and may also for this reason have a disadvantageous effect on the inductive power transmission efficiency.

### SUMMARY

In this respect, it is an object of the invention, among others, to suggest an improved coil wire support element which overcomes the disadvantages noted above, which provides for an improved inductive power transfer efficiency when used in an inductive power transfer conductor.

Accordingly, a coil wire support element is provided and includes a support member and a coil wire section. The support member includes a front wall and a back wall arranged at the respective ends of the support member. The front wall and back wall extend away from the support member. The coil wire section includes a wire coiled on the support member in a coil wire layer such that a height h3 of the coil wire layer is larger a height h1 of the front wall.

### BRIEF DESCRIPTION OF THE DRAWINGS

The objectives, features and advantages of the invention will become more apparent by explaining further the invention with reference to the accompanying drawings and detailed embodiments in the following, in which:

FIG. 1a is a sectional view of a coil wire support element according to the invention;

FIG. 1b is a cross-sectional view of the coil wire support element of FIG. 1a along the line A-A;

FIG. 2a is a sectional view of another coil wire support element according to the invention;

FIG. 2b is a cross-section of the coil wire support element of FIG. 2a along the line A-A;

FIG. 3a is an enlarged view of section S1 of the coil wire support element of FIG. 2a;

FIG. 3b is enlarged view of another embodiment of the section S1 of the coil wire support element of FIG. 2a;

FIG. 4a is a sectional view of another coil wire support element according to the invention;

FIG. 4b is a cross-section of the coil wire support element of FIG. 4a along the line A-A; and

FIG. 5 is a sectional view of a coil wire support element according to the invention in an inductive power transfer coupler and a receptacle coupler.

### DETAILED DESCRIPTION OF THE EMBODIMENT(S)

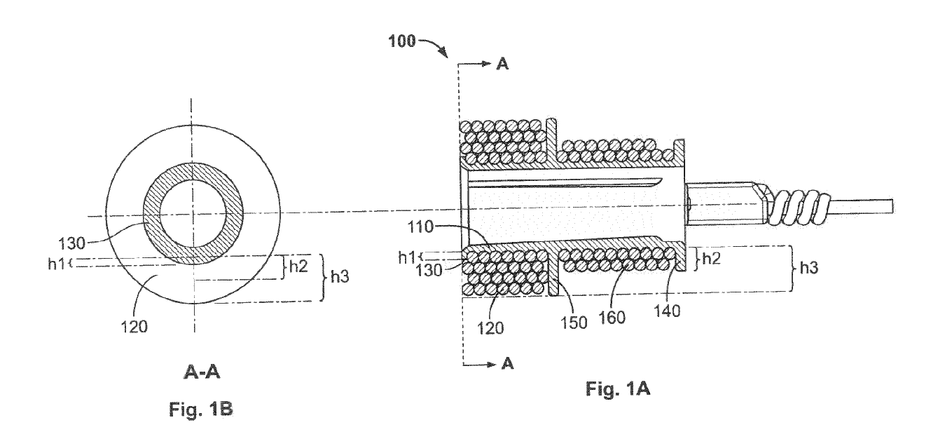

Referring to FIGS. 1a and 1b, a coil wire support element 100 according to the invention is shown.

The coil wire support element 100 may be used for inductive power transfer in an inductive power transfer coupler as will become apparent from the later description and, hence, may be an integral part of said coupler.

Irrespective of usage, the coil wire support element 100 of the embodiment shown in FIGS. 1a and 1b includes a support member 110 and a coil wire section 120. The support member is configured to support a coil wire coiled thereon in the coil wire section 120. The coil wire section 120 is formed of coil wire that is coiled on the support member in at least one coil wire layer.

In the shown embodiment, the support member 110 is a tubular member with a cylindrical cross section. The support member 110 allows for the coil wire to be coiled in the coil wire section 120 in at least one coil wire layer so that it rests on the outside of the support member 110. In this respect, the coil wire section 120 protrudes from the support member 110 in an outward direction.

Specifically, the coil wire of the coil wire section 120 is coiled in loops around the support member 110 so that the electromotive force is induced with directivity between a front and a back end of the support member 110.

In other words, a front and a back end of the support member 110 may be defined as those surfaces of the support member 110 which are not covered by the coil wire section 120 and are located opposite to each other. Generally, the arrangement of the coil wire in the coil wire section 120 specifies an axial direction of the coil wire support element 100, namely as a direction between a front and a back end of the support member 110.

Further, with this definition of an axial direction of the coil wire support element 100 in mind, a radial direction then defines directions perpendicular to the axial direction, i.e. directions perpendicular to the axis connecting the front and the back end of the support member 110. In other words, for the coil wire support element 100 a radial direction is pointing outwardly from the outer surface of the support member 110.

Accordingly, the coil wire section 120 is made of coil wire arranged around the support member 110 and protrudes from the support member 110 in a radial direction.

Generally, it is to be pointed out that for the coil wire support member 110 the term “radial direction” is defined on the basis of the loop-shaped arrangement of the coil wire in the coil wire section 120 and, hence, does not require a circular cross-section for the support member 110. In this respect, the term “radial direction” should not be understood as limiting the invention, as the “radial direction” may also be defined for support members 110 with a rectangular, polygonal or elliptical cross-section.

At the front and the back end of the support member 110, a front wall 130 and a back wall 140 are provided. The front and back walls 130, 140 protrude in a radial direction from the support member.

Further, the coil wire support element 100 includes an intermediate wall 150 arranged between the front wall 130 and the back wall 140 and extending away from the support member 110 in a radial direction. Specifically, in this configuration the front wall 130 and the intermediate wall 150 provide lateral support to the coil wire to form the first coil wire section 120 and the intermediate wall 150 and the back wall 140 provide lateral support to the coil wire to form the second coil wire section 160.

In the coil wire support element 100, the coil wire of the first coil wire section 120 is electrically connected to the coil wire of the second coil wire section 160 in order to enhance the induced electromotive force. Further, the number of coil wire layers that are arranged in the first coil wire section 120 is greater than the number of coil wire layers that are arranged in the second coil wire section 160.

More particularly, the coil wire of the first, bottommost coil wire layer in the coil wire section 120 borders on the front wall 130 and on the intermediate wall 150 so that the front wall 130 and the intermediate wall 150 provide lateral support for the first coil wire layer.

In an embodiment a coil wire support element 100 without an intermediate wall 150, the coil wire section 120 may be formed of coil wire that is coiled around the support member 110 in at least one coil wire layer extending between the front and the back wall, so that the front and the back wall provide lateral support to part of the coil wire, e.g. the first, bottommost coil wire layer of the coil wire section 120.

Consequently, the front wall 130, and optionally the back wall 140 or the intermediate wall 150, are provided according to this particular height configuration in order to provide for the effect of allowing coiling of at least one coil wire layer in closer proximity to the front face of the coil wire support element 100.

As shown in FIGS. 1a and 1b, the height h2 of the back wall 140, i.e. the segment thereof that protrudes from the support member 110 in the radial direction, is larger than the height h1 of the front wall 130, i.e. the segment thereof that protrudes from the support member 110 in said radial direction.

Further in FIGS. 1a and 1b, the height h3 of the intermediate wall 150, i.e. the segment thereof that protrudes from the support member 110 in the radial direction, is larger than the height h1 of the front wall 130, i.e. the segment thereof that protrudes from the support member 110 in the radial direction, and the height h3 of the intermediate wall 150, i.e. the segment thereof that protrudes from the support member 110 in the radial direction, is larger than the height h2 of the back wall 140, i.e. the segment thereof that protrudes from the support member 110 in the radial direction.

More particularly, the front wall 130 is configured with a height h1 in the radial direction that is smaller than the height h3 of the coil wire layers in coil wire section 120. In other words, the height h3 of the coil wire layers, coiled in said one coil wire section 120 on the support member 110, is larger in the radial direction than the height h1 of the segment of the front wall 130 protruding in said radial direction from the support member 110.

In this respect, for instance, the last, outmost layer of the at least one coil wire layer in coil wire section 120 may project into the empty space on top of the front wall 130 and, hence, be in closer proximity to the front face of the coil wire support element 100.

In other words, due to the smaller height h1 of the front wall 130, the upper surface of the front wall 130 is lower with respect to the height of the at least one coil wire section 120. Accordingly, front-most coil wire loops of the at least one coil wire section 120 can be coiled onto the support member in the first, bottommost coil wire layer and also can be coiled onto the upper surface of the front wall 130 in a subsequent coil wire layer, such that a front-most coil wire loop of this subsequent coil wire layer is in closer proximity to the front face of the coil wire support element 100.

As shown in FIGS. 1a and 1b, the front of the second and the fourth coil wire layer in coil wire section 120 (assuming an inclining numbering of coil wire layers starting from the bottommost coil wire layer coiled on the support member 110) project into the empty space on top of the front wall 130. Also, the front-most coil wire loop of the second coil wire layer is coiled onto the outer surface of the front wall 130 so as to be in close proximity to the front face of the coil wire support element 100.

Consequently, it can be readily appreciated that due to the structure of the coil wire support element 100 of this first embodiment, namely due to the coil wire support element 100 comprising a front wall 130 at the front end of the support member 110 where the front wall 130 protrudes to height h1 in a radial direction from support member 110 and the height h1 is less than the height h3 of the at least one coil wire layer in the coil wire section 120 on the support member 110, the coil wire support element 100 allows for an improved inductive power transfer efficiency when used in an inductive power transfer coupler.

The term “height” is to be understood in the context of the invention as the length of a segment, of e.g. the front wall 130, protruding in the radial direction from the support member 110. In this respect, the outer surface of the support member 110 is a basis for the height of the front wall 130. In other words, a portion of the front wall 130 providing for the structural connection with the support member 110 and corresponding to the frontal area of the support member 110 does not add to the height of the front wall in the meaning of the invention.

Consequently, the definition of height for the front wall 130 refers to the same basis as the definition of height of the coil wires in the coil wire section 120, namely the basis being provided by support member 110. The height of the front wall 130 is to be measured from the support member 110 in a radial direction and the height of the coil wire section 120 is also to be measured from the support member 110 in a radial direction.

As a variation of the coil wire support element 100 described above, where a coil wire support element 100 only includes a single, first coil wire layer of coil wire coiled on the support member 110, this single, first coil wire layer is larger in a radial direction on the support member 110 than the height of the front wall 130 protruding in a radial direction from the support member 110.

As another variation of the coil wire support element 100 described above, where a coil wire support element 100 includes a plurality of coil wire layers of coil wire coiled on the support member 110, the total height of the coil wire layers in said one coil wire section 120 is larger in the radial direction than the height of the segment of the front wall 130 protruding in said radial direction from the support member 110.

As a further variation of the coil wire support element 100 described above, where a coil wire support element 100 includes a plurality of coil wire layers of coil wire coiled on the support member 110, the total height of coil wire layer(s) in said one coil wire section 120 is larger in the radial direction than the height of the segment of the front wall 130 protruding in said radial direction from the support member 110.

According to yet another variation of the coil wire support element 100 described above, the back wall 140 includes an opening for guiding the coil wire away from the support member 110, e.g. to rearward placed circuitry when used in an inductive power transfer coupler.

In a further variation of the coil wire support element 100 described above, the support member 110 includes a structural element (e.g. a notch or a protrusion) for determining/keying the rotational orientation for winding/coiling the coil wire on the support member. Accordingly, the structural element allows specifying an assembly/manufacturing alignment for in between processes and handling. Alternatively, the structural element may also be provided on the front wall 130 such that the assembly/manufacturing alignment is not determined until the flange is removed.

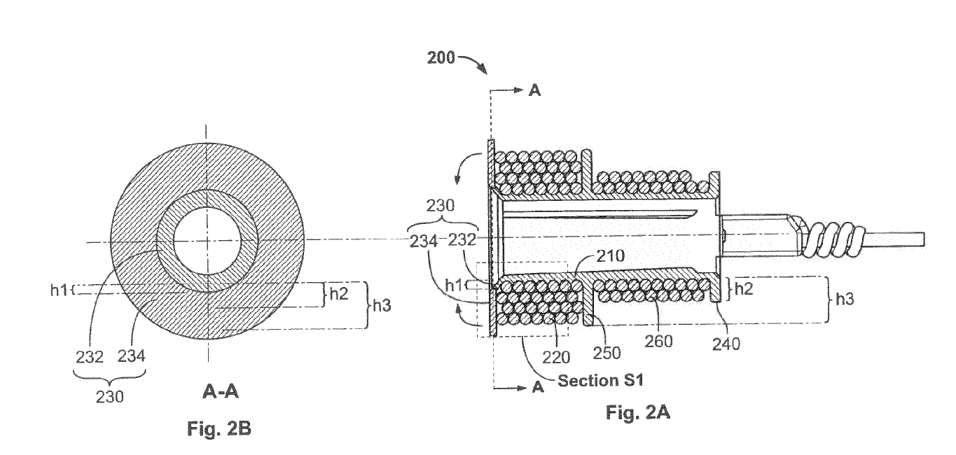

Now with reference to FIGS. 2a and 2b, another coil wire support element 200 according to the invention is shown.

The coil wire support element 200 includes a support member 210 and a coil wire section 220. The support member 210 is configured to support a coil wire coiled thereon in the coil wire section 220. The coil wire section 220 is formed of coil wire that is coiled on the support member 210 in at least one coil wire layer.

In the shown embodiment, the support member 210 is a tubular member with a cylindrical cross section. The support member 210 allows for the coil wire to be coiled in the coil wire section 220 in at least one coil wire layer so that is rests on the outside of the support member 210. In this respect, the coil wire section 220 protrudes from the support member 210 in an outward direction.

Specifically, the coil wire of the coil wire section 220 is coiled in loops around the support member 210 so that the electromotive force is induced with directivity between a front and a back end of the support member 210.

In other words, a front and a back end of the support member 210 may be defined as those surfaces of the support member 210 which are not covered by the coil wire section 220 and are located opposite to each other. Generally, the arrangement of the coil wire in the coil wire section 220 specifies an axial direction of the coil wire support element 200, namely as a direction between a front and a back end of the support member 210.

Further, with this definition of an axial direction of the coil wire support element 200 in mind, a radial direction then defines directions perpendicular to the axial direction, i.e. directions perpendicular to the axis connecting the front and the back end of the support member 210. In other words, for the coil wire support element 200 a radial direction is pointing outwardly from the outer surface of the support member 210.

Accordingly, the coil wire section 220 is made of coil wire arranged around the support member 210 and protrudes from the support member 210 in a radial direction.

Generally, it is to be pointed out that the definition of a “radial direction” for the coil wire support member 210 is based on the loop-shaped arrangement of the coil wire in the coil wire section 220 and, hence, does not require a circular cross-section for the support member 210. In this respect, the term “radial direction” should not be understood as limiting the invention, as the “radial direction” may also be defined for support members 210 with a rectangular, polygonal or elliptical cross-section.

A front wall 230 and a back wall 240 are provided at the front and at the back end of the support member 210, respectively. The front and back walls 230, 240 protrude in a radial direction from the support member.

Specifically, the front wall 230 of the coil wire support element 200 in the shown embodiment includes a non-removable segment 232 and a removable segment 234, wherein removal of the removable segment 234 enables reducing the height of the front wall 230 to the height h1 of the non-removable segment 232 of the front wall 230 protruding in said radial direction from the support member 210.

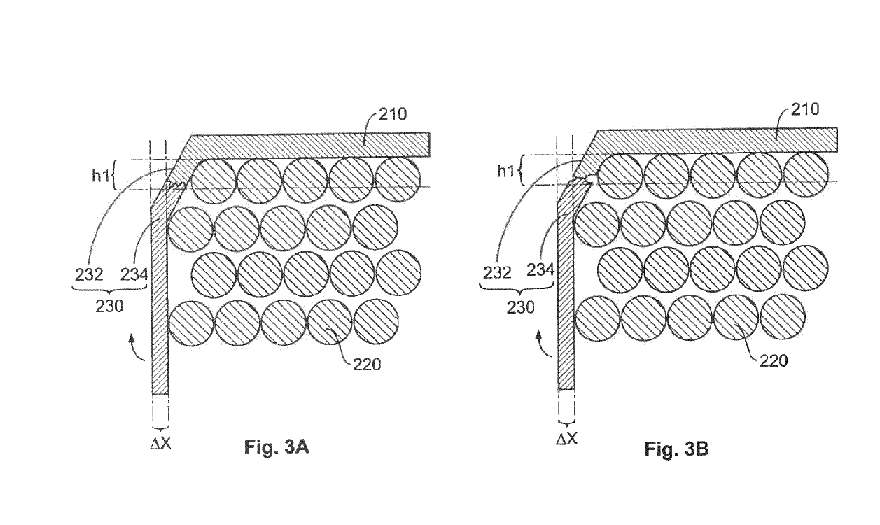

According to shown embodiment, the front wall 230 includes a thinned section or a perforated section arranged as a predetermined breaking point for enabling breaking off the removable segment 234 of the front wall 230. The implementation of the coil wire support element 200 where the front wall 230 includes the thinned section arranged as a predetermined breaking point is shown in FIG. 3b.

According to another exemplary implementation of the coil wire support element 200, the front wall 230 includes at least one latching member or a thread arranged to form a detachable connection between the non-removable segment 232 and the removable segment 234 of the front wall 230. The exemplary implementation of the coil wire support element 200 where the front wall 230 includes the thread to form a detachable connection between the non-removable segment 232 and the removable segment 234 of the front wall is illustrated in FIG. 3a.

Further, the coil wire support element 200 includes an intermediate wall 250 arranged to protrude from the support member 210 in a radial direction between the front wall 230 and the back wall 240. Specifically, in this configuration the front wall 230 and the intermediate wall 250 provide for lateral support to coil wire arranged in coil wire layers to form the first coil wire section 220, and the intermediate wall 250 and the back wall 240 provide for lateral support to the coil wire arranged in coil wire layers to form the second coil wire section 260.

In the coil wire support element 200, the coil wire of the first coil wire section 220 is electrically connected to the coil wire of the second coil wire section 260 in order to enhance the induced electromotive force. Further, the number of coil wire layers that are arranged in the first coil wire section 220, is greater than the number of coil wire layers that are arranged in the second coil wire section 260.

More particularly, the coil wire of the first, bottommost coil wire layer in the coil wire section 220 borders on the non-removable segment 232 of the front wall 230 and on the intermediate wall 250 so that the non-removable segment 232 of the front wall 230 and the intermediate wall 250 provide lateral support for the first coil wire layer.

Consequently, due to the provision of the front wall 230 having the non-removable segment 232 and the removable segment 234, removal of the removable segment 234 enables reducing the height of the front wall 230 to the height h1 of the non-removable segment 232 of the front wall 230 protruding in said radial direction from the support member 210. Thereby, it is also possible to provide for the effect of allowing coiling of at least one coil wire layer to be in closer proximity to the front face of the coil wire support element 200.

The advantage of the configuration of the coil wire supporting element 200 is shown in FIGS. 3a and 3b where the distance reduction after removal of the removable segment 234 of the front wall 230 is shown as length. In detail, due to the removal of the removable segment 234 of the front wall 230, the coil wire of the coil wire section 220 can be located by the total length of in the axial direction at closer proximity to the front face of the coil wire support element 200.

As shown in FIGS. 2a and 2b, the height h2 of the back wall 240, i.e. the segment thereof that protrudes from the support member 210 in the radial direction, is larger than the height h1 of the non-removable segment 232 of the front wall 230 protruding from the support member 210 in said radial direction.

Further shown in FIGS. 2a and 2b, the height h3 of the intermediate wall 250, i.e. the segment thereof that protrudes from the support member 210 in the radial direction, is larger than the height h1 of the non-removable segment 232 of the front wall 230 protruding from the support member 210 in said radial direction, and the height h3 of the intermediate wall 250, i.e. the segment thereof that protrudes from the support member 210 in the radial direction, is larger than the height h2 of the back wall 240, i.e. the segment thereof that protrudes from the support member 210 in the radial direction.

More particularly, the non-removable segment 232 of the front wall 230 is configured with a height h1 in the radial direction that is smaller than the height h3 of the coil wire layers in coil wire section 320. In other words, the height h3 of the coil wire layers, coiled in said one coil wire section 220 on the support member 210, is larger in the radial direction than the height h1 of the non-removable segment 232 of the front wall 230 protruding in said radial direction from the support member 210.

In this respect, for instance, the last, outmost layer of the at least one coil wire layer in coil wire section 220 may project into the empty space on top of the front wall 230 and, hence, be in close proximity to the front face of the coil wire support element 200.

As shown in FIG. 2a and the enlarged views of section S1 in FIGS. 3a and 3b, the front of the second and the fourth coil wire layer in coil wire section 220 (assuming an inclining numbering of coil wire layers starting from the bottommost coil wire layer coiled on the support member 210) project into the empty space on top of the non-removable segment 232 of the front wall 230.

Consequently, it can be readily appreciated that due to the structure of the coil wire support element 200 of this second embodiment, namely due to of the front wall 230 comprising the non-removable segment 232 and the removable segment 234, removal of the removable segment 234 enables positioning the coil wire section 220 at closer proximity to the front face of the coil wire support element 200 by the total length of in the axial direction, thereby allowing for an improved inductive power transfer efficiency when used in an inductive power transfer coupler.

As a variation of the coil wire support element 200 described above, where the coil wire support element 200 includes in the coil wire section 220 only a single, first coil wire layer of coil wire coiled on the support member 210, this single, first coil wire layer is larger in a radial direction on the support member 210 than the height of the non-removable segment 232 of the front wall 230 protruding in a radial direction from the support member 210.

As another variation of the coil wire support element 200 described above, where the coil wire support element 200 includes a plurality of coil wire layers on the support member 210, the total height of the coil wire layers in said one coil wire section 220 is larger in the radial direction than the height of the non-removable segment 232 of the front wall 230 protruding in said radial direction from the support member 210.

As a further variation of the coil wire support element 200 described above, where the coil wire support element 200 includes a plurality of coil wire layers on the support member 210, the total height of coil wire layer(s) in said one coil wire section 220 is larger in the radial direction than the height of the non-removable segment 232 of the front wall 230 protruding in said radial direction from the support member 210.

In an even further variation of the coil wire support element 200 described above, the support member 210 includes a structural element (e.g. a notch or a protrusion) for determining/keying the rotational orientation for winding/coiling the coil wire on the support member. Accordingly, the structural element allows specifying an assembly/manufacturing alignment for in between processes and handling. Alternatively, the structural element may also be provided on the front wall 230 such that the assembly/manufacturing alignment is not determined until the removable segment 234 is removed.

According to yet another variation of the coil wire support element 200 described above, the back wall 240 includes an opening for guiding the coil wire away from the support member 210, e.g. to rearward placed circuitry when used in an inductive power transfer coupler.

Next, a method for manufacturing a coil wire support element 200 will be described. Firstly, a support member 210 is provided for supporting a coil wire in at least one coil wire section 220, wherein the support member 210 includes at least one front and one back wall 230, 240 at the respective ends of the support member 210, and the front and back walls 230, 240 protruding from the support member 210 in a radial direction for providing lateral support to the coil wire of the at least one coil wire section 220. Next, a coil wire is coiled on the support member 210 to form said one coil wire section 220 arranged in at least one wire layer. The front wall 230 includes a non-removable segment 232 and a removable segment 234. Additional steps may also be performed, such as of removing the removable segment 234 of the front wall 230 after coiling in order to reduce the height of the front wall 230 to the height of the non-removable segment 232 protruding in said radial direction from the support member 210.

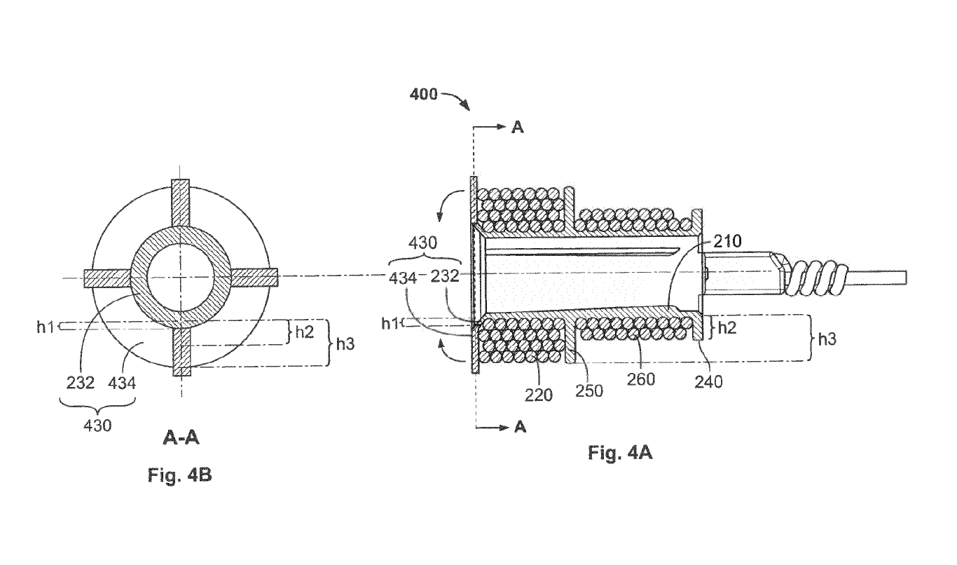

Now with reference to FIGS. 4a and 4b, another coil wire support element 400 according to the invention will be described.

The coil wire support element 400 of FIGS. 4a and 4b is based on the coil wire support element 200 of FIGS. 2a and 2b where corresponding parts are given corresponding reference numerals and terms. The detailed description of corresponding parts has been omitted for reasons of conciseness.

The coil wire support element 400 of FIGS. 4a and 4b differs from the coil wire support element 200 in that the front wall 430 includes a non-removable segment 232 which corresponds to that non-removable segment 232 of the coil wire support element 200 and a plurality of removable segments 434.

Due to the provision of the plurality of removable segments 434, removal thereof from the front wall 430 can be facilitated, in particular in case of an exemplary implementation of the coil wire support element 400, where the front wall 430 includes a thinned section or a perforated section arranged at a predetermined breaking point for enabling breaking off the removable segment 434 from the front wall 430. In this implementation, the thinned section or the perforated section is shorter so as to reduce the force necessary for removal of the removable segment 434 from the front wall 430.

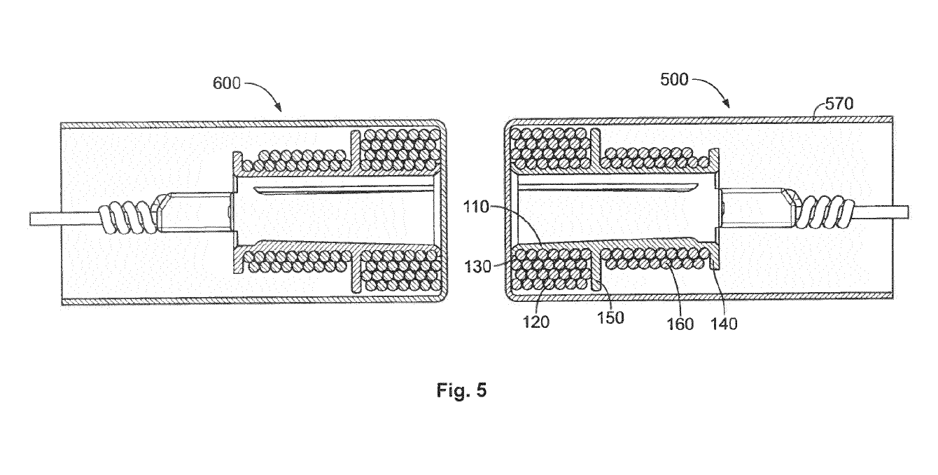

With reference to FIG. 5, a coil wire support element according to the invention is shown with an inductive power transfer coupler 500 and a receptacle coupler 600.

As indicated in FIG. 5, the coil wire support element included in the inductive power transfer coupler 500 may be realized according to the coil wire support element 100. Similarly, the coil wire support element included in the inductive power transfer coupler 500 may also be realized according to the coil wire support element 200 or 400 of FIGS. 2a and 2b, or 4a and 4b, where the respective removable segment 234 or removable segments 434 have been removed prior to assembly in the inductive power transfer coupler 500.

The receptacle coupler 600 may be an inductive power transfer coupler of same or similar kind to the inductive power transfer coupler 500.

The coil wire support element is surrounded at the outside with a non-conductive cover layer 570 to ensure that the coupler has a sufficient level of mechanical robustness/stability. The non-conductive cover layer 570 may be realized as an overmold.

The foregoing illustrates some of the possibilities for practicing the invention. Many other embodiments to the invention are possible and within the scope and spirit of the invention. It is, therefore, intended that the foregoing description be regarded as illustrative rather than limiting, and that the scope of the invention is given by the appended claims together with their full range of equivalents.

What is claimed is:

1. A coil wire support element comprising:
a support member having a front wall and a back wall arranged at respective ends of the support member and extending away from the support member; and
a coil wire section having a wire coiled on the support member in a coil wire layer such that a height h3 of the coil wire layer is larger than a height of the front wall.

2. The coil wire support element according to claim 1, wherein the coil wire section includes a plurality of coil wire layers coiled on the support member.

3. The coil wire support element according to claim 1, wherein a height of the back wall protruding from the support member is larger than the height of the front wall.

4. The coil wire support element according to claim 1, further comprising an intermediate wall extending from the support member and positioned between the front wall and the back wall.

5. The coil wire support element according to claim 4, further comprising a second coil wire section having a coil wire coiled on the support member and positioned between the intermediate wall and the back wall and electrically connected to the coil wire section.

6. The coil wire support element according to claim 5, wherein the second coil wire section includes a plurality of wire layers coiled on the support member.

7. The coil wire support element according to claim 6, wherein the coil wire section includes a plurality of wire layers that is greater than the plurality of wire layers of the second coil wire section.

8. The coil wire support element according to claim 7, wherein a height of the intermediate wall is greater than the height of the front wall.

9. The coil wire support element according to claim 8, wherein the height h3 of the intermediate wall is greater than a height of the back wall.

10. A coil wire support element comprising:
a support member;
a coil wire section having a wire coiled on the support member;
a front wall positioned at one end of the support member and having a non-removable segment and a removable segment; and
a back wall positioned at an opposite end of the support member with respect to the front wall.

11. The coil wire support element according to claim 10, wherein the front wall includes a thinned section arranged as a predetermined breaking point.

12. The coil wire support element according to claim 10, wherein the front wall includes a latching member between the non-removable segment and the removable segment.

13. The coil wire support element according to claim 10, wherein the coil wire section includes a plurality of coil wire layers having a total height that is larger than a height of the non-removable segment.

14. The coil wire support element according to claim 13, wherein a height of the back wall is larger than the height of the non-removable segment.

15. The coil wire support element according to claim 10, further comprising an intermediate wall extending from the support member and positioned between the front wall and the back wall.

16. The coil wire support element according to claim 15, further comprising a second coil wire section having coil wire coiled on the support member and positioned between the intermediate wall and the back wall and electrically connected to the coil wire section.

17. The coil wire support element according to claim 16, wherein the second coil wire section includes a plurality of wire layers coiled on the support member.

18. The coil wire support element according to claim 17, wherein the coil wire section include a plurality of wire players that is greater than the plurality of wire layers of the second coil wire section.

19. A method of manufacturing a coil wire support element, comprising the steps of:
providing a support member having a front wall with a non-removable and a removable segment and positioned at one end of the support member and a back wall extending from the support member and positioned at an opposite end thereof;
coiling a wire on the support member to form a coil wire section having a wire layer.

20. The method of manufacturing a coil wire support element according to claim 19, further comprising the step of removing the removable segment after coiling the wire on the support member.
